(19) United States
(12) Patent Application Publication
(10) Pub. No.: US 2013/0113503 A1
(43) Pub. Date: May 9, 2013

(54) METHOD AND DEVICE FOR MEASURING THE LOCATION OF A PARTICLE BEAM PRESENT IN PACKETS IN A LINEAR ACCELERATOR

(71) Applicants: Marcel Ruf, Erlangen (DE); Lorenz-Peter Schmidt, Hessdorf (DE); Stefan Setzer, Furth (DE)

(72) Inventors: Marcel Ruf, Erlangen (DE); Lorenz-Peter Schmidt, Hessdorf (DE); Stefan Setzer, Furth (DE)

(21) Appl. No.: 13/510,954

(22) PCT Filed: Nov. 4, 2010
(86) PCT No.: PCT/EP10/66813

§ 371 Date: May 20, 2012

(30) Foreign Application Priority Data
Nov. 20, 2009 (DE) 10 2009 054 070.9

(51) Int. Cl. G01B 7/00

(52) U.S. Cl. CPC G01B 7/003
USPC 324/654; 324/96; 324/658

(57) ABSTRACT

The invention relates to a method and device for measuring the location of a particle beam (10) present in packets in a linear accelerator comprising a hollow chamber structure (4) in which an electromagnetic wave oscillating at a base frequency (f₀) is generated in order to accelerate the particles, wherein an electrical measurement signal (M) generated by the particle beam (10) by means of electromagnetic interaction with the measurement recorder (16) is recorded by at least one measurement recorder (16) disposed in the hollow chamber structure (4), said signal being a function of the distance between the measurement recorder (16) and the particle beam (10). According to the invention, the measurement signal (M) is analyzed in a frequency range different from the base frequency (f₀) and higher natural frequencies of the hollow chamber structure (4), comprising a whole multiple of the base frequency (f₀).

The present patent document is a §371 nationalization of PCT Application Serial Number PCT/EP2010/066813, filed Nov. 4, 2010, designating the United States, which is hereby incorporated by reference. This patent document also claims the benefit of DE 10 2009 054 070.9, filed on Nov. 20, 2009, which is also hereby incorporated by reference.

### BACKGROUND

The present embodiments relate to a method and a device for measuring the location of a particle beam present in packets in a linear accelerator.

Charged particles are accelerated in a linear accelerator in a cavity structure extended in the direction of a longitudinal axis by a standing-wave high-frequency electromagnetic wave propagating axially in the cavity structure. The electrical field of the standing-wave high-frequency electromagnetic wave in an area of the longitudinal axis is parallel to the cavity structure.

For the effective utilization of the accelerated particles at the end of the linear accelerator, the precise position of the particle beam with regard to a reference point is significant. Even small changes in this beam position may have a negative effect on the intended use. This situation arises, for example, in systems for non-destructive material testing or in linear accelerators used in medicine for cancer therapy. In such cases, X-ray bremsstrahlung is generated with electrons with energies of, for example, a few MeV on a target. The properties of the beam profile generated are susceptible in such cases under some circumstances to the positioning of the electron beam on the target.

To measure the position of a (bunched) particle beam present in packets (e.g., bunches) in a particle accelerator, one of the known approaches is to arrange a plurality of measuring probes (e.g., pickup probes) in the vicinity of the particle beam. A measurement signal is generated in the plurality of measuring probes inductively or capacitively. The measurement signal depends on the location of the particle beam relative to the measurement probe. In such a measurement probe operating on a capacitive or inductive basis, use is made of the fact that the packets or bunches pass the measurement probe with a frequency corresponding to the basic frequency of the electromagnetic wave and generate a corresponding high-frequency measurement signal in the probe. If there is no spatial separation of measurement probes and cavities, this measurement signal (e.g., useful signal) is, however, overlaid on a basic signal oscillating at the same frequency that is generated in the measurement probe by the electromagnetic wave accelerating the particles. To measure the location of a particle beam with this type of capacitive or inductive measurement probe, these probes are therefore disposed remote from the actual accelerator section in order to avoid the undesired interference. Such a spatial separation of measurement probe and accelerator section is, however, not possible in compact linear accelerators such as have come to be used in medical technology.

### SUMMARY AND DESCRIPTION

The present embodiments may obviate one or more of the drawbacks or limitations in the related art. For example, a method and a device for measuring the location of a particle beam present in bunches that are able to be used with a low technical outlay in compact particle accelerators are provided.

To measure the location of a particle beam present in bunches in a linear accelerator having a hollow structure, in which, for accelerating particles, an electromagnetic wave oscillating at a basic frequency is generated. At least one measurement probe is disposed within the hollow structure. An electrical measurements signal created by the particle beam by electromagnetic interaction with the measurement probe is picked up. The electrical measurements signal depends on a distance between the measurement probe and the particle beam. The measurement signal is evaluated in a frequency range including an integer multiple of a basic frequency different from the basic frequency and higher-frequency eigenfrequencies of the hollow structure.

Although the basic frequency of the electrical signal generated by the particle beam in the measurement probe matches the basic frequency of the electromagnetic wave causing the acceleration of the particles, frequency spectrums differ. While the measurement signal generated by the particle beam has higher harmonic frequency components that are a whole-number multiple of the basic frequency, in the higher harmonic modes that are present in the hollow structure of the linear accelerator, this may not be the case. In other words, the eigenfrequencies of the higher harmonic modes present in the hollow structure do not correspond to a whole-number multiple of the (basic) frequency in the basic mode. By evaluating the measurement signal in a frequency device including a whole-number multiple of the basic frequency different from the basic frequency and higher-frequency eigenfrequencies of the hollow structure, the measurement signals generated in the measurement probe may be separated (e.g., an actual useful signal from the signals that are generated in the measurement probe by the electromagnetic waves oscillating in the hollow structure). In this way, a precise location determination of the particle beam is possible even when the measurement probe is disposed within the hollow structure, and the measurement signals generated by the particle beam in the measurement probe are smaller by orders of magnitude than the signals generated by the electromagnetic waves in the hollow structure. Since the determination of the location of the particle beam is undertaken on the basis of electromagnetic interaction, and the particle beam is not significantly influenced, deviations from a required location during ongoing operation, on the basis of which a precise location correction of the particle beam with deflection units controlled in accordance with the deviation may be carried out, may be determined. Correct positioning of the location of the electron beam in relation to a reference point may be provided.

If the hollow structure has a plurality of cavities with at least one intermediate area disposed between adjacent cavities of the plurality of cavities, in which the field strength of the electromagnetic wave giving rise to the acceleration is lower than the field strength in the cavities, and the at least one measurement probe is positioned in the intermediate area, the influence of the electromagnetic wave present within the hollow structure on the measurement signal may be additionally reduced.

The measurement accuracy is additionally increased if the measurement signals of two measurement probes are picked up in each case. The two measurement probes are disposed in pairs opposite one another symmetrical to the central axis of the linear accelerator (e.g., at an identical distance to the central axis). In this case, a differential signal that only differs from zero when the particle beam deviates from the central axis (e.g., the required location) may be derived.

### BRIEF DESCRIPTION OF THE DRAWINGS

FIG. 1 shows one embodiment of a linear accelerator for generating high-energy particles;

FIG. 2 shows a diagram, in which an exemplary signal amplitude of a measurement signal picked up by a measurement probe is plotted against a frequency;

FIG. 3 shows a basic diagram of one embodiment of an evaluation circuit, in which the measurement signals picked up by the measurement probe are further processed;

FIG. 4 shows one embodiment of a linear accelerator, in which a plurality of capacitive measurement probes are disposed; and

FIG. 5 shows an alternate embodiment of the linear accelerator with inductive measurement probes.

### DETAILED DESCRIPTION OF THE DRAWINGS

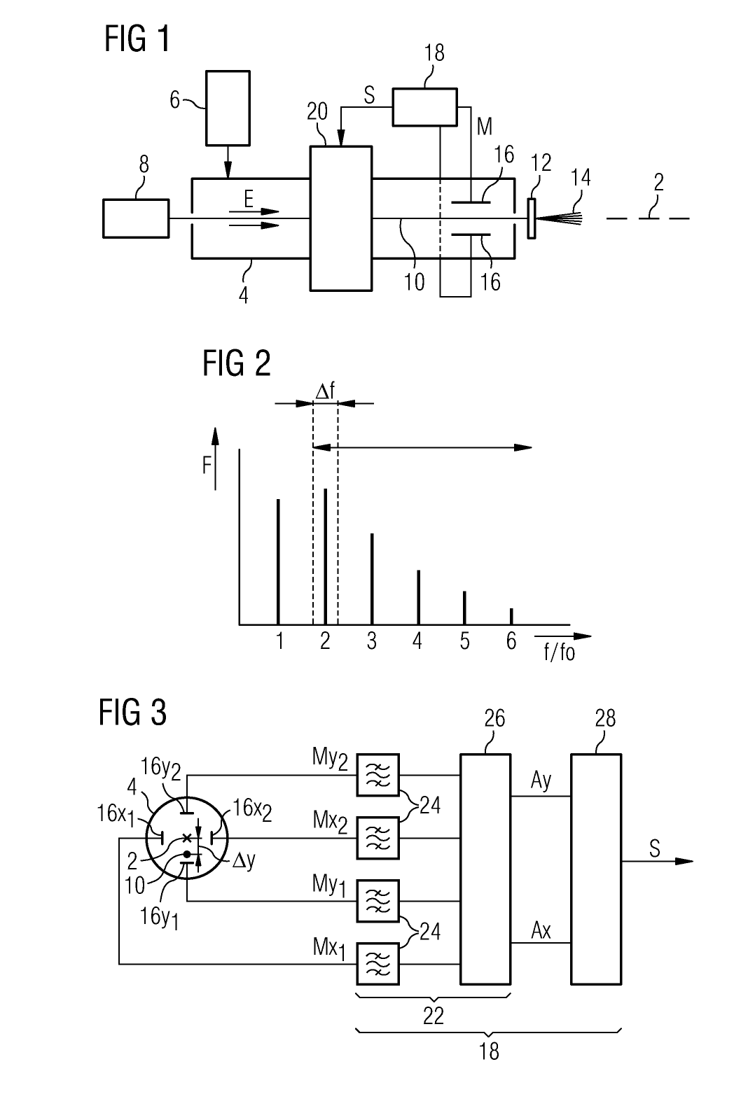

In accordance with FIG. 1, a linear accelerator includes a hollow structure 4 extending along a central axis 2. An electromagnetic wave is injected into the hollow structure 4 by a high-frequency source 6. An electrical field E of the electromagnetic wave is oriented in the immediate vicinity of the central axis 2 in parallel to the central axis. A particle beam 10 generated by a particle source 8 is accelerated in the electrical field E of the electromagnetic wave generated in the hollow structure 4. In one embodiment, this involves an electron beam that, after leaving the hollow structure 4, hits a target 12 and generates gamma rays 14 at the target 12. The gamma rays 14 are used, for example, for therapeutic purposes in radiotherapy or in non-destructive materials testing. Since the electrons are accelerated in the linear accelerator by an electromagnetic wave oscillating at a basic frequency fₒ, particles in the particle beam 10 are present in packets (e.g., bunches). A packet sequence frequency of the packets corresponds to the basic frequency f₀.

Disposed within the hollow structure 4 are measurement probes 16 in pairs symmetrical to the central axis 2 (e.g., at the same distance from the central axis 2 lying opposite one another). The measurement probes pick up a measurement signal M generated by the particle beam 10 through electromagnetic interaction, the frequency spectrum of which, in addition to the basic frequency f₀, contains higher-frequency harmonic frequencies that are a whole-number multiple of the basic frequency f₀. The measurement signals M are evaluated and processed in an evaluation and control device 18, and a control signal S, with which an electromagnetic deflection unit 20 for regulating the location of the particle beam 10 is controlled, is generated.

In one embodiment, an amplitude spectrum S of the measurement signal M picked up by the measurement probe is shown simplified in FIG. 2 plotted against the frequency f/f₀. FIG. 2 shows that the measurement signal, as well as a component oscillating at the basic frequency f₀, contains narrowband frequency components at higher harmonic frequencies f/f₀=2, 3, . . . , of which the half power widths are much smaller than the basic frequency f₀. These frequency components may differ from the frequencies, with which the hollow structure oscillates in higher modes. The measurement signal SM may be detected in a frequency range lying above the basic frequency f₀ in a narrow frequency band Δf in each case. The measurement signal SM is separated clearly enough from frequencies, in which the cavity, after excitation with the basic frequency f₀, may oscillate in higher modes f>f₀. Thus, for example, with a capacitive measurement probe, the signal may be processed with the second harmonic (e.g., f/f₀=2). This corresponds, at a basic frequency of f₀=3 GHz, to signal processing in a frequency range around 6 GHz.

FIG. 3 shows that each of the two measurement probes 16x_{1,2}, 16y_{1,2} is disposed in a pair opposite one another symmetrical to the central axis 2 in order to measure the location of the particle beam 10 within the hollow structure 4. In the example shown in FIG. 3, the particle beam 10 in the horizontal axis y differs by a distance Δy from an ideal position along the central axis 2 (e.g., a desired location). The measurement signals Mx_{1,2}, My_{1,2} of each measurement probe 16x_{1,2}, 16y_{1,2} are conveyed to an evaluation circuit 22, filtered at the evaluation circuit 22 with a bandpass filter 24, and converted with a signal processing unit 26 into an output signal Δx, Δy correlated with the beam location. The output signal Δx, Δy generated in this way is accordingly a measure for an amplitude of the measurement signal Mx_{1,2}, My_{1,2} in the frequency band of the bandpass filter F 24 (e.g., f₀±Δf/2).

By evaluating the measurement signals Mx_{1,2}, My_{1,2} of respective measurement probes 16x_{1,2}, 16y_{1,2} lying opposite one another, the deviation of the particle beam 10 in the direction of the connecting axis of the two respective measurement probes 16x_{1,2}, 16y_{1,2} lying opposite one another may be determined directly.

Control signals S may subsequently be derived in a control unit 28 from the output signals Δx and Δy for control of deflection units 20 (FIG. 1), in order to regulate the location of the particle beam 10 to a desired value. In this way, evaluation circuit 22 and control unit 28 form the control and evaluation device 18 shown schematically in FIG. 1 as one unit.

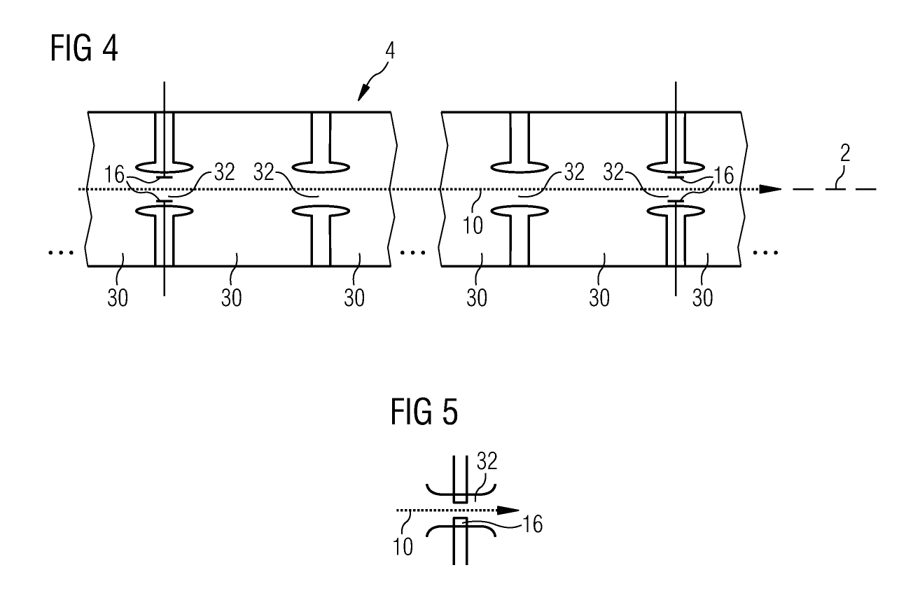

FIG. 4 shows a schematic diagram of the structure of the standing-wave linear accelerator, in which the hollow structure 4 is formed by a plurality of cavities 30 disposed behind one another in the direction of the central axis 2. The plurality of cavities 30 are separated from one another by intermediate areas 32, in which the particle beam 10 does not experience any acceleration or only a slight acceleration. In the intermediate areas 32, the field strength of the electromagnetic wave causing the acceleration is lower than in the plurality of cavities 30. The measurement probes 16 may each be arranged in one of the intermediate areas 32. A plurality of intermediate areas 32 is equipped with measurement probes 16 within the linear accelerator.

The measurement probes 16 may, however, be disposed at other positions within the hollow structure 4 (e.g., in the plurality of cavities 30 essentially effecting the acceleration of the particles).

In the example of FIG. 4, capacitive measurement probes 16 are shown. The capacitive measurement probes 16 are each formed by a disk-shaped plate.

As an alternative to the example shown in FIG. 4, in accordance with FIG. 5, inductive measurement probes 16 may also be used. The inductive measurement probes 16 are formed by a flat conductor loop, a loop of which is arranged in one plane that contains the central axis 2.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for measuring a location of a particle beam present in packets in a linear accelerator comprising a hollow structure, the method comprising:
generating an electromagnetic wave oscillating at a basic frequency to accelerate particles;
picking up, by at least one measurement probe disposed within the hollow structure, an electrical measurement signal generated by electromagnetic interaction with the at least one measurement probe, the electrical measurement signal depending on a distance between the at least one measurement probe and the particle beam; and
evaluating the electrical measurement signal in a frequency range comprising a whole-number multiple of the basic frequency differing from the basic frequency and higher-frequency eigenfrequencies of the hollow structure.

2. The method as claimed in claim 1, wherein the hollow structure comprises a plurality of cavities and at least one intermediate area disposed between adjacent cavities of the plurality of cavities, a field strength of the electromagnetic wave in the intermediate area causing the acceleration being lower than a field strength of the electromagnetic wave in the plurality of cavities, and
wherein the at least one measurement probe is disposed in the intermediate area.

3. The method as claimed in claim 1, wherein the at least one measurement probe comprises two measurement probes, and
wherein the electrical measurement signal of each of the two measurement probes is picked up, the two measurement probes being_disposed in pairs opposite one another symmetrical to a central axis of the linear accelerator.

4. The method as claimed in claim 1, wherein the at least one measurement probe comprises a capacitive measurement probe.

5. The method as claimed in claim 1, wherein the at least one measurement probe comprises an inductive measurement probe.

6. A device for measuring a location of a particle beam in a linear accelerator comprising a hollow structure, the linear accelerator operable, for accelerating particles, to generate an electromagnetic wave oscillating at a basic frequency, the device comprising:
at least one measurement probe positionable within the hollow structure, the at least one measurement probe operable to pick up an electrical measurement signal generated by the particle beam through electromagnetic interaction with the at least one measurement probe, electrical measurement signal depending on a distance between the at least one measurement probe and the particle beam; and
an evaluation circuit operable to evaluate the electrical measurement signal in a frequency range comprising a whole-number multiple of the basic frequency differing from the basic frequency and higher-frequency eigenfrequencies of the hollow structure.

7. The device as claimed in claim 6, wherein the measurement probe comprises a capacitive measurement probe.

8. The device as claimed in claim 6, wherein the measurement probe comprises an inductive measurement probe.

9. A linear accelerator comprising:
a device for measuring a location of a particle beam in a linear accelerator comprising a hollow structure, the linear accelerator operable, for accelerating particles, to generate an electromagnetic wave oscillating at a basic frequency, the device comprising:
at least one measurement probe positionable within the hollow structure, the at least one measurement probe operable to pick up an electrical measurement signal generated by the particle beam through electromagnetic interaction with the at least one measurement probe, the electrical measurement signal depending on a distance between the at least one measurement probe and the particle beam; and
an evaluation circuit operable to evaluate the electrical measurement signal in a frequency range comprising a whole-number multiple of the basic frequency differing from the basic frequency and higher-frequency eigenfrequencies of the hollow structure.

10. The linear accelerator as claimed in claim 9, wherein the hollow structure includes a plurality of cavities arranged behind one another and at least one intermediate area disposed between adjacent cavities of the plurality of cavities,
wherein a field strength of the electromagnetic wave causing the acceleration in the at least one intermediate area is lower than a field strength in the plurality of cavities, and
wherein the at least one measurement probe is disposed in the at least one intermediate area.

11. The linear accelerator as claimed in claim 9, wherein the at least one measurement probe comprises a plurality of measurement probes, and
wherein the plurality of measurement probes is disposed in pairs opposite one another symmetrical to a central axis of the linear accelerator.

12. The linear accelerator as claimed in claim 9, further comprising a control unit and a deflection unit operable to regulate the location of the particle beam as a function of an output signal or output signals generated by the evaluation circuit.

13. The method as claimed in claim 2, wherein the at least one measurement probe comprises two measurement probes, and
wherein the measurement signal of each of the two measurement probes is picked up, the two measurement probes being disposed in a pair opposite one another symmetrical to a central axis of the linear accelerator.

14. The method as claimed in claim 2, wherein the at least one measurement probe comprises a capacitive measurement probe.

15. The method as claimed in claim 3, wherein at least one measurement probe of the two measurement probes comprises a capacitive measurement probe.

16. The method as claimed in claim 2, wherein the at least one measurement probe comprises an inductive measurement probe.

17. The method as claimed in claim 3, wherein at least one measurement probe of the two measurement probes comprises an inductive measurement probe.

18. The linear accelerator as claimed in claim 10, wherein the at least one measurement probe comprises a plurality of measurement probes, and
wherein the plurality of measurement probes is disposed in pairs opposite one another symmetrical to a central axis of the linear accelerator.

19. The linear accelerator as claimed in claim 10, further comprising a control unit and a deflection unit operable to regulate the location of the particle beam as a function of an output signal or output signals generated by the evaluation circuit.

20. The linear accelerator as claimed in claim 11, further comprising a control unit and a deflection unit operable to regulate the location of the particle beam as a function of an output signal or output signals generated by the evaluation circuit.
